(19) United States
(12) Patent Application Publication
(10) Pub. No.: US 2008/0070191 A1
(43) Pub. Date: Mar. 20, 2008

(54) Method for Forming Polychromatic Pressable Porcelain Dental Restoration

(75) Inventor: Sean Ricks, Gardena, CA (US)

Correspondence Address: CROWELL & MORING LLP;INTELLECTUAL PROPERTY GROUP, P.O. BOX 14300, WASHINGTON, DC, 20044-4300, US

(73) Assignee: Den-Mat Corporation, Santa Maria, CA (US)

(21) Appl. No.: 11/840,803

(22) Filed: Aug. 17, 2007

Related U.S. Application Data
(60) Provisional application No. 60/841,539, filed on Sep. 1, 2006.

(51) Int. Cl. A61C 13/083

(52) U.S. Cl. 433/202.1; 433/223

(57) ABSTRACT

A method for forming a polychromatic pressable porcelain dental restoration. A wax model of the dental restoration is prepared as is commonly used in the lost wax technique. Chards or pieces of porcelain are embedded into the wax model. The porcelain embedded wax model is then used in the common pressable porcelain technique to form a polychromatic porcelain dental restoration with natural tooth shading.

### BACKGROUND

1. Field of the Invention

The invention relates to the dental arts and the ceramic arts.

2. State of the Art

Dental restorations are well known in the art. Common dental restorations include inlays, onlays, crowns, and veneers. One method of forming dental restorations involves using the lost wax technique. The lost wax technique is a well-known method in the metallurgical sciences wherein a wax or polystyrene model is replaced by molten metal. In the case of dentistry, the wax model is replaced by porcelain after the wax is burned out.

The formation of a dental restoration by the lost wax technique previously required the following steps:

1. Tooth preparation: In this step a portion of the tooth was removed, for example the removal of 1.5 to 2 mm of tooth structure, i.e., enamel or dentin. This step was necessary to provide a preparation of the tooth without undercuts and to allow for a final metal ceramic or metal resin restoration that was of adequate thickness.

2. Impression (negative mold): An impression material such as a hydrocolloid, polyester rubber, or vinyl polysilicone (VPS) was used to make an impression of the prepared teeth.

3. Stone model formation: The impression was then used by the laboratory technician to create a stone or epoxy model with removable dies that were an accurate copy of the prepared tooth, i.e., to create a positive replication of the tooth (see FIG. 1).

4. Spacer application: A die spacer was then applied to the die, which affords appropriate relief in a range of 20 to 36 microns to allow space for a dental cement or bonding agent to secure the final restoration to the patient's prepared tooth (see FIG. 2).

5. A lubricant or a release agent was then placed over the die spacer to ensure easy removal of the wax from the stone model.

6. Wax up: A wax model of the dental restoration was then fabricated over the lubricated die. That is, the wax was built up over the stone model of the tooth to the desired dimension of the final restoration (see FIG. 3).

7. Investing/Casting: The wax pattern was then invested in high heat investment or refractory material and cast from a molten metal using the “lost wax” technique and a centrifuge process to form a metal coping or substructure of the restoration.

8. The ceramic or visible portion of the restoration was then formed by applying and baking successive layers of porcelain powders mixed with distilled water or other types of porcelain building-up liquids, first to opaque over the metal coping to hide the metal color and then to shape the porcelain from its various transition shades to create as natural an appearance as possible. The temperatures of this baking were a function of individual vendor's particular protocol.

An improvement on this technology was the development of pressable restorations. These restorations are so named because the porcelain is pressed into a void in the refractory material. In the first step of this process, a wax model of the final restoration or veneer is formed by the method described above in steps 1-6 and the wax model is removed from the stone model of the tooth. The wax model is then mounted on a pedestal connected to a ring former base. The model is mounted on the pedestal using a wax sprue (see FIG. 4). Several restorations can be mounted on a single pedestal using one sprue per restoration. The sprues are generally mounted at an angle of between 30° and 60° with respect to the upper surface of the pedestal. The pedestal and sprue elevate the model up from the ring former base, suspending the model in the air. In the case of veneers, several veneer models can be mounted or sprued on a single pedestal if they are arranged in a turbine shape (see FIG. 5). In order to determine the amount of porcelain required to form the restoration, the model(s) and sprue(s) are weighed. This is typically accomplished by weighing the ring former/pedestal without the sprues and models, weighing ring former/pedestal and sprues and models together, and then subtracting the former from the latter.

A ring is then placed around the pedestal on the ring former base. The ring fits snugly on a raised portion of the ring former base (see FIG. 6). The ring completely encompasses the pedestal, sprues, and models. Typically, at least 10 mm clearance is provided for all around the model(s) by the ring, which is typically made of paper but can also be made of an elastomer. The size of the ring is typically chosen based on the determined weight of the wax. A stabilizer ring may be placed over the upper rim of the ring in order to provide additional support (see FIG. 7). The ring is then filled with a castable refractory or investment material. Typically, the ring volume is slowly filled to ensure there is minimal formation of air bubbles in the investment material. The ring is typically filled to the bottom of the stabilizer ring. The stabilizer ring is then replaced with a leveling ring. The leveling ring displaces the refractory material out a hole in its center and creates a button on the top of the refractory material (see FIG. 8). This results in the refractory material completely encompassing the pedestal, sprues, and models. Typically, all areas of the ring former base/pedestal, the ring, and the leveling ring that are to come into contact with the refractory material are lubricated to prevent adhesion to the refractory. Typically, petroleum jelly or a Teflon-Silicone spray are used as the lubricant.

The refractory material is then allowed to solidify resulting in a refractory material cylinder. Typically, solidification requires at least a half hour of set time. The refractory material cylinder is then removed from the ring former base/pedestal and the leveling ring. This is typically accomplished by twisting the base/pedestal and the leveling ring so as to break away the refractory material from the surfaces of each. The paper ring is then removed. The roughness created by the removal of the button and leveling ring is then removed by a cutting instrument (see FIG. 9). The paper ring may also leave a seam down the side of the refractory material cylinder. This seam can be smoothed in a similar manner.

The refractory material cylinder encompassing the wax sprue(s) and model(s) is then placed in a burnout furnace or oven. The cylinder is placed with the pedestal opening down. The burnout oven is typically set at around 900° C. In this heated environment, the wax composing the sprue(s) and model(s) melts and then burns or evaporates off through the void created by the pedestal. A cylinder of the refractory material remains with a negative of the shape of the model connected to a passageway, created by the void left by the pedestal, via the void left by the sprue. The pedestal can also be made of wax and detachable from the ring former base. In this case, the pedestal is not lubricated and does not break off with the base but remains inside the refractory material cylinder. The wax pedestal is then burned off as described above leaving the void described above.

Porcelain is then pressed into the model negative (restoration mold) through the void left by the pedestal. This is typically accomplished by first selecting the amount and size of porcelain ingots needed to form the restoration. This is calculated based on the measured wax weight. Typically, porcelain ingot manufacturers provide charts correlating the size and number of ingots to use with the measured weight of the wax. The porcelain ingot is then placed into the hole in the refractory cylinder. A plunger is then placed into the hole above the porcelain (see FIG. 10). The plunger is typically made of aluminum oxide although other refractory materials may be used. The plunger is then used to force the porcelain into the restoration mold. The pressing process typically stops when porcelain fills the voids left by the model and the sprue. This whole process typically takes place in a press furnace. The pressing of the porcelain typically takes place under a high vacuum and at high temperatures up to 2000° C. Press furnaces can be preprogrammed with certain heating and vacuum press cycles for different types and amounts of porcelain. The porcelain ingot and plunger may also be preheated before being placed into the refractory cylinder.

After the mold is removed from the press furnace and cooled, the next step involves the divesting of the refractory material cylinder from the porcelain restoration. This is typically accomplished by cutting the refractory cylinder with a separating disk at the point where the bottom of the plunger lies. This point is estimated by placing an identical plunger next to the embedded plunger and marking on the refractory cylinder surface the end of the plunger (see FIG. 11). The cylinder is cut all along its circumference (see FIG. 12) and then the material is pried off using a plaster knife or similar tool. The remaining investment material is then removed with a sandblaster using a suitable abrasive such as alumina, quartz, or glass beads (see FIG. 13).

The sprue is then removed from the restoration by cutting the sprue near its base using a diamond disk (see FIG. 14). The remaining material is then removed using a ceramic stone or other abrasive. The porcelain restoration can then be fit on the stone model after removing the spacer and acute adjustments can be made as required.

The pressable porcelain process disadvantageously results in a monochromatic porcelain restoration because a single homogeneous porcelain ingot is used as the source of porcelain. However, in nature human teeth are composed of enamel, dentin, and connective and vascular tissue (pulp). As teeth develop, they take on a polychromatic appearance. Age and environmental factors cause discoloration. Thus, in order to accurately match the natural appearance of teeth, an external stain must be applied to the pressed porcelain dental restoration to characterize and produce a polychromatic effect. The stain is susceptible to abrasion and may wear away over time. Therefore, there remains a need for a pressable porcelain process that provides a natural polychromatic appearance and is not susceptible to fading or wearing away with time.

### SUMMARY OF THE INVENTION

One embodiment of the invention is a method for making a pressable porcelain restoration. In an initial step, a wax model of a tooth structure is created. Chards or pieces of porcelain are then incorporated into the wax model. The porcelain embedded wax model is then mounted on a ring former base using a wax sprue. A filling vessel is then placed around the wax model. The vessel is then filled with a castable refractory material. The refractory material is allowed to solidify to form a refractory material shape. The wax from within the solidified refractory material shape is removed to form a refractory material shape with a void in the shape of the wax model with the embedded porcelain remaining in the void. A porcelain ingot is provided to the void. The porcelain ingot is pressed under vacuum into the void to fill the void with porcelain. The pressed porcelain is allowed to cool. The refractory material is removed from about the pressed porcelain to provide a solid polychromatic porcelain restoration with a natural tooth color.

### BRIEF DESCRIPTION OF THE DRAWINGS

FIG. 1 shows a stone model of a patient's teeth.

FIG. 2 shows a die spacer applied to the tooth model.

FIG. 3 shows the creation of the wax model of the dental restoration.

FIG. 4 shows the mounting of the wax models to a pedestal/ring former base using wax sprues.

FIG. 5 shows a plurality of wax models of veneers mounted on a pedestal in a turbine-shaped arrangement.

FIG. 6 shows the tight fit between the ring former base and a ring.

FIG. 7 shows the application of a stabilizer ring to the upper rim of the ring.

FIG. 8 shows the use of a leveling ring to bring the level of the refractory material even with the level of the upper rim of the ring.

FIG. 9 shows the button created by the leveling ring.

FIG. 10 shows the positioning of a plunger into the void left by the pedestal.

FIG. 11 shows the estimation of the level of the bottom of the plunger after porcelain is pressed into a mold.

FIG. 12 shows the initial cut made into a refractory cylinder in order to divest the refractory material from the final dental restoration.

FIG. 13 shows the sandblasting of the remaining refractory material from the final dental restoration.

FIG. 14 shows the removal of a porcelain sprue from the final dental restoration.

FIG. 15a shows a frontal view of an elongated shard of porcelain.

FIG. 15b shows a frontal view of a truncated elliptical-shaped shard of porcelain.

FIG. 16a shows a frontal view of a wax model of a dental restoration on a stone model of a tooth.

FIG. 16b shows a frontal view of elongated shards of porcelain applied to a wax model of an incisal tooth restoration.

FIG. 16c shows a frontal view of a truncated elliptical-shaped shard of porcelain applied to a wax model of a gingival tooth restoration.

FIG. 17a shows a sagital view of a wax model of a dental restoration on a stone model of a tooth.

FIG. 17b shows a sagital view of elongated shards of porcelain applied to a wax model of an incisal tooth restoration.

FIG. 17c shows a sagital view of a truncated elliptical-shaped shard of porcelain applied to a wax model of a gingival tooth restoration.

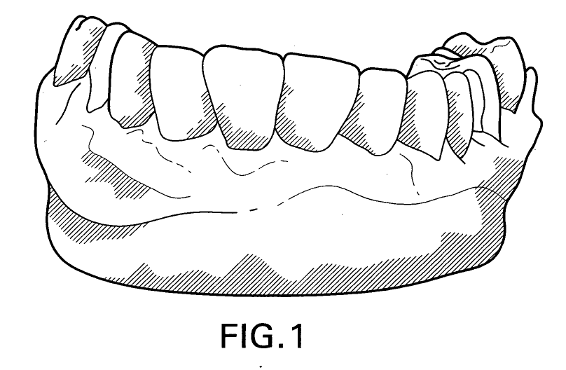

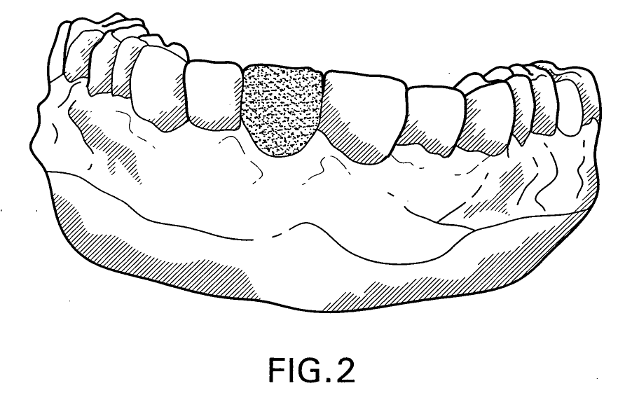

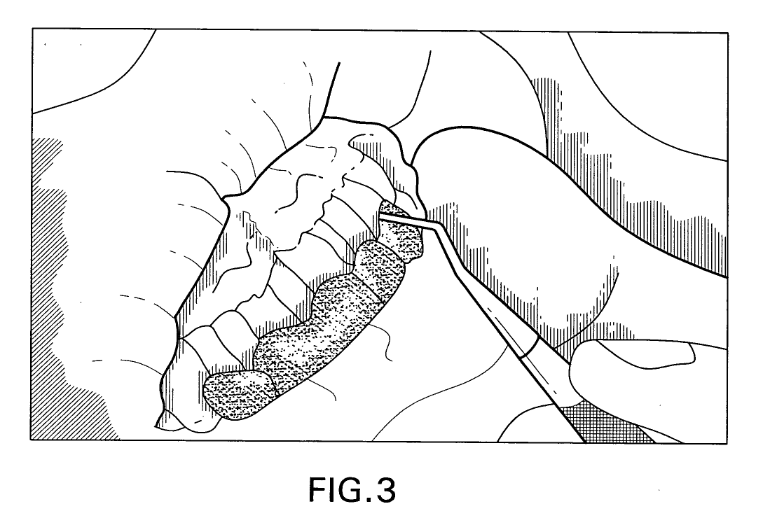

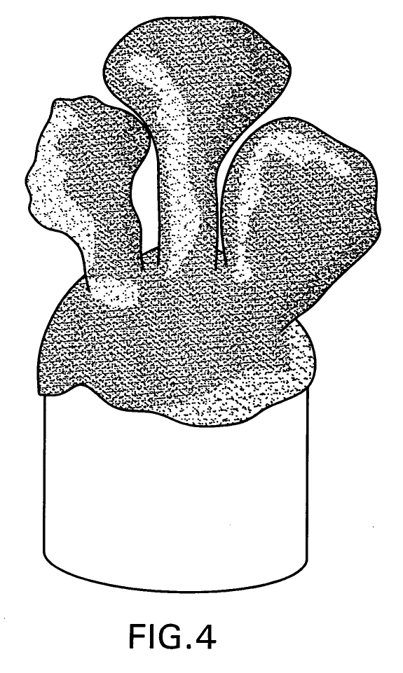

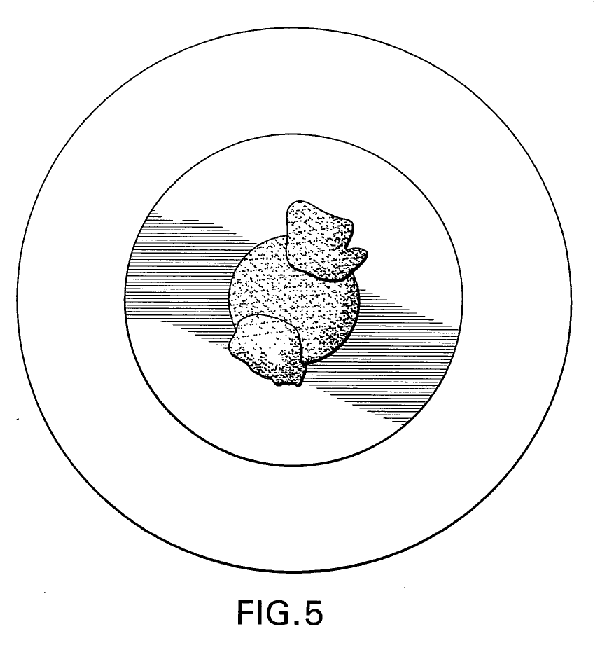

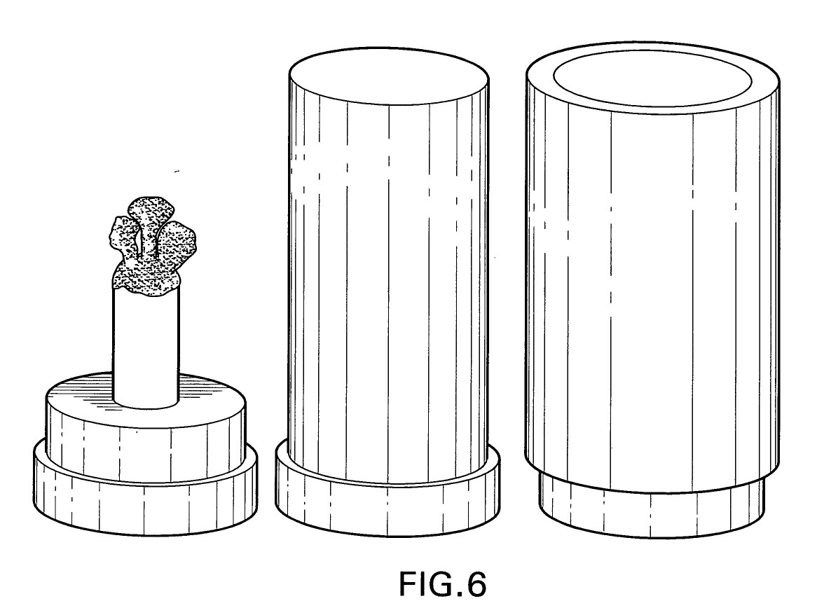

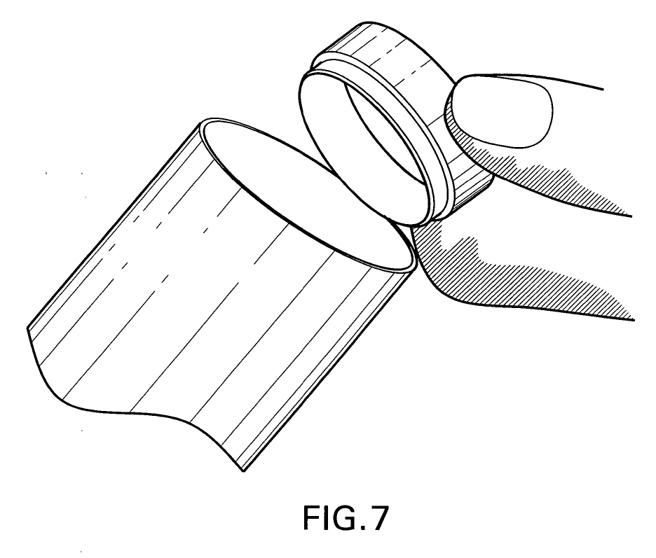

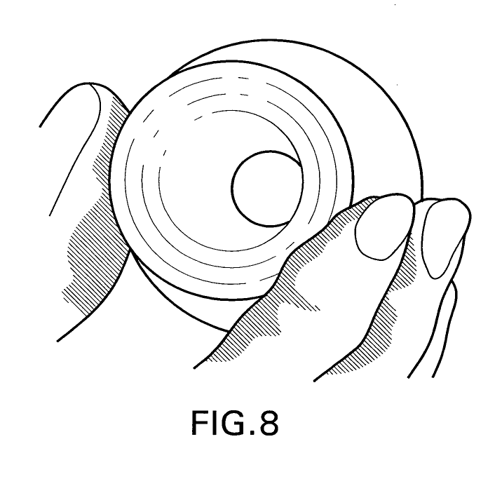

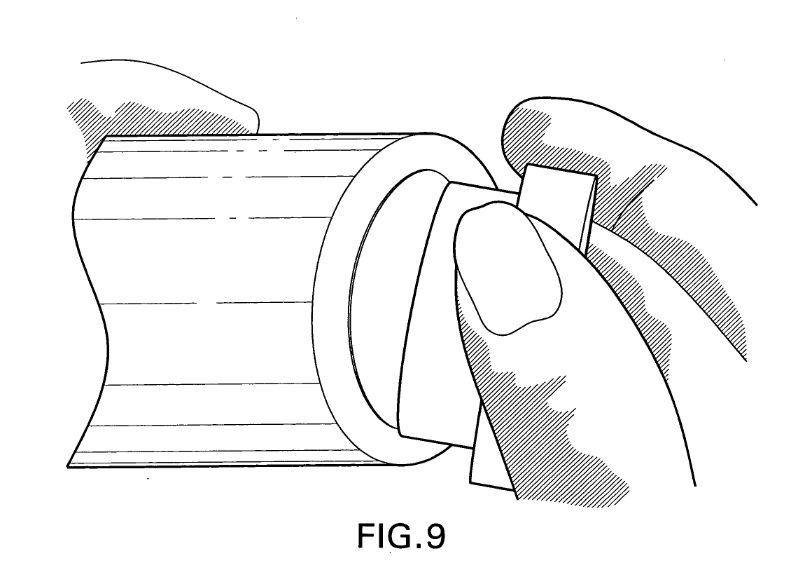

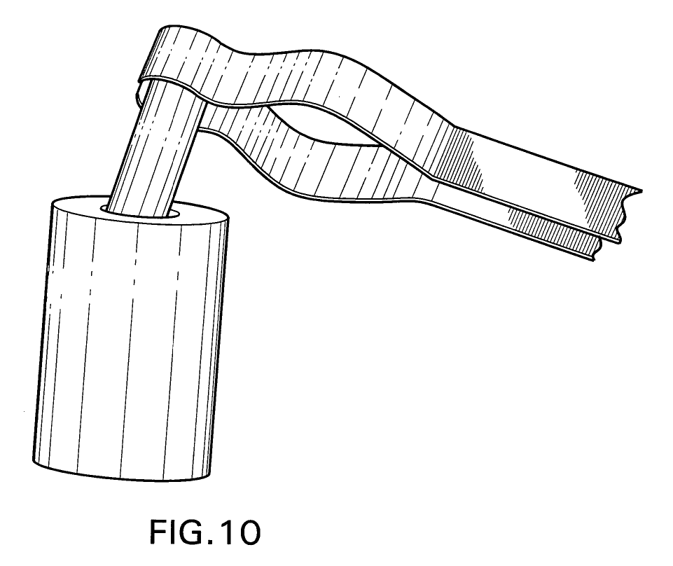

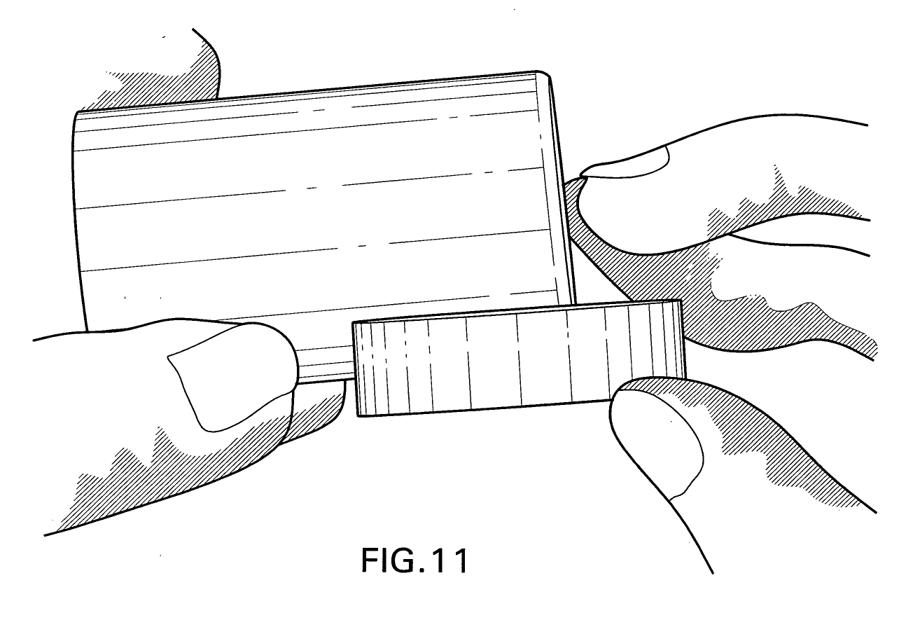

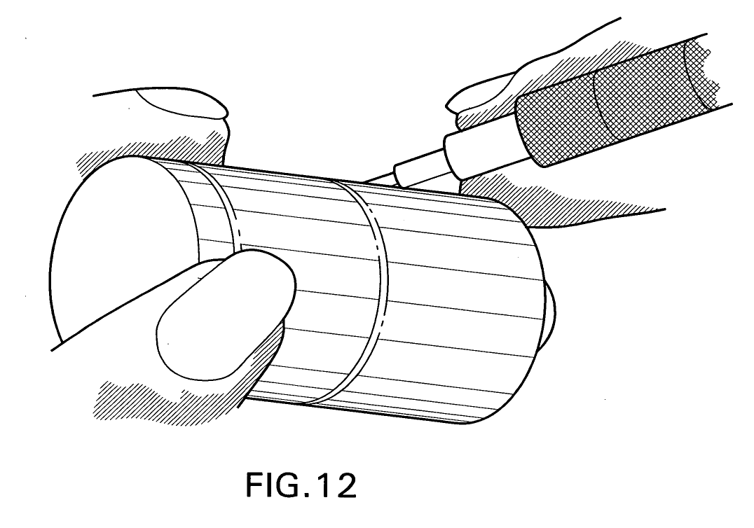

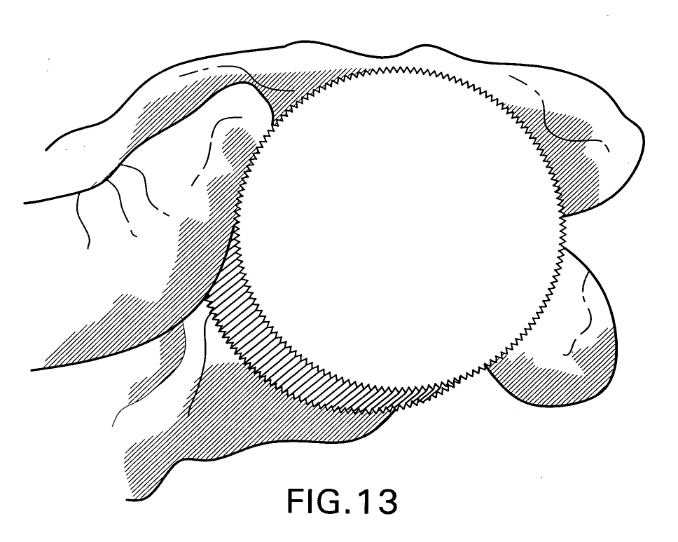

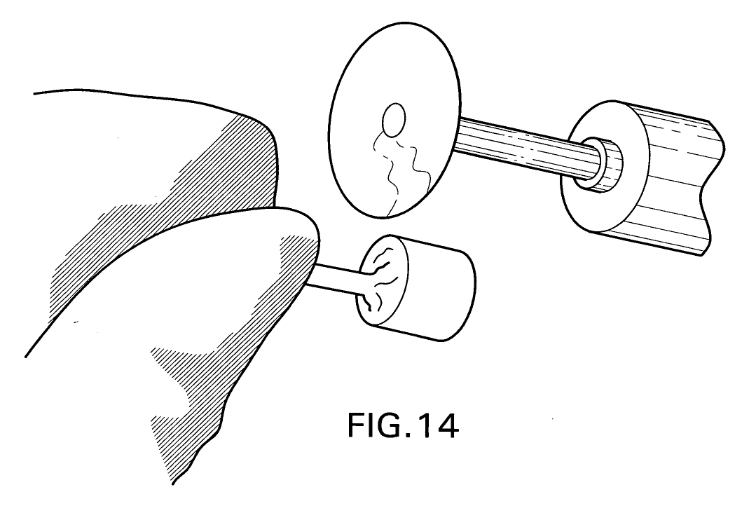

### DETAILED DESCRIPTION

The drawings and the following detailed descriptions show specific embodiments of the invention. Numerous specific details including materials, dimensions, and products are provided to illustrate the invention and to provide a more thorough understanding of the invention. However, it will be obvious to one skilled in the art that the present invention may be practiced without these specific details.

One embodiment of the present invention is a method for making a polychromatic pressable porcelain dental restoration. A wax model of the dental restoration is prepared as above. However, prepared chards or pieces of porcelain are incorporated into the wax model. The chards of porcelain can be of any desired shade and can be placed at specific locations to ensure the proper shade graduation of the final restoration.

Preferably, the shards of porcelain are embedded into the wax model by heating the wax model in order to melt the wax. More preferably, for forming an incisal restoration, the wax model is formed on a stone model of the teeth and the wax model is then heated with a blade of an instrument called a waxer which creates a valley of molten wax. The porcelain shard is then placed into the valley prior to the molten wax hardening around it. Preferably, for forming a gingival restoration, a truncated elliptical-shaped disk of porcelain is heated and pressed onto the wax of a wax model melting the wax. The melted wax then hardens around the and holds the disk into place. Alternatively, the porcelain chards can be embedded into the wax model by cutting back portions of the wax model and inserting chards of porcelain into those portions cut away or by just pushing chards of porcelain into the wax model. The porcelain may be embedded into the wax model while the wax model is attached to the stone model or after the wax model is removed from the stone model. In the former case, the porcelain embedded wax model is then removed from the stone tooth model for further processing.

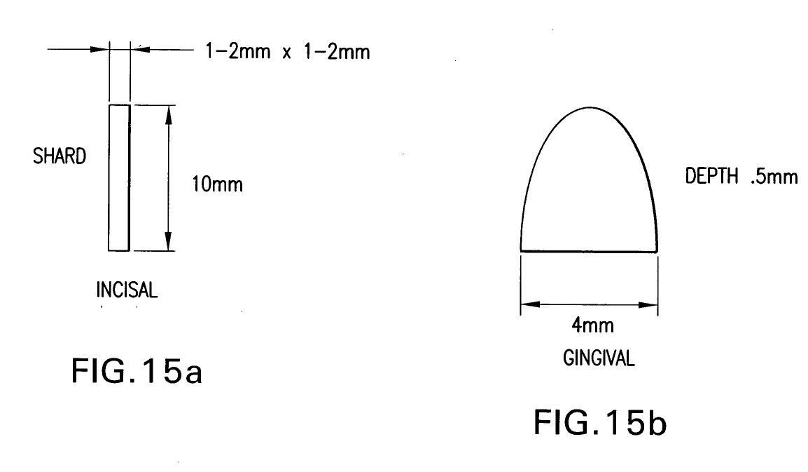

Any size or shape of porcelain can be used as the porcelain shards for embedding into the wax model. Preferably, for formation of an incisal restoration, the shards are cut to various sizes approximately 10 mm in length and anywhere from 1 mm to 2 mm width square. Preferably, for formation of a gingival restoration, the chards are of elliptical graduation starting at a point and graduating bilaterally to a width of about 4 mm by 0.5 mm in thickness for gingival characterization. FIG. 15a shows a frontal view of a porcelain shard for formation of an incisal restoration. FIG. 15b shows a frontal view of a porcelain disc for formation of a gingival restoration.

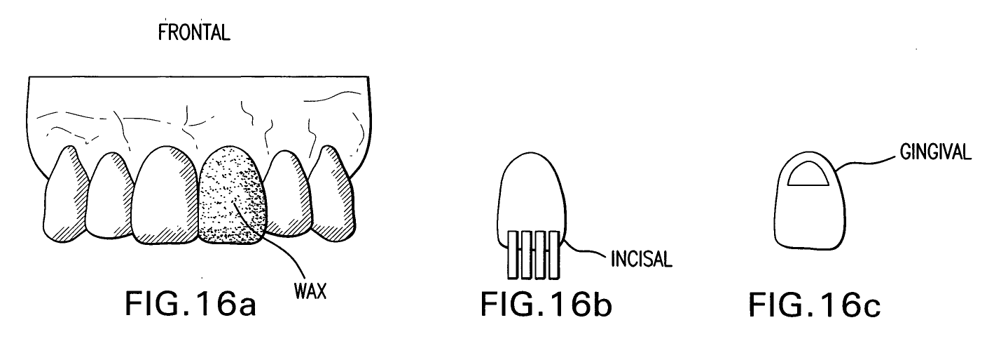

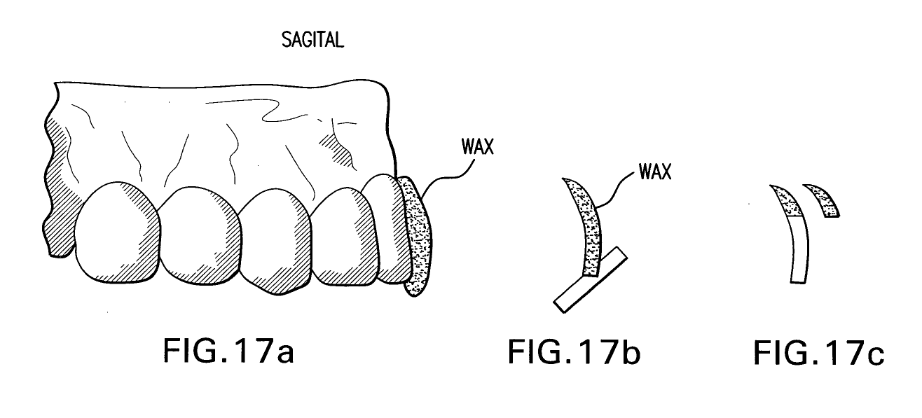

Any number of chards can be embedded into a wax model and in any location on the wax model. Preferably, for formation of an incisal restoration, a series of elongated porcelain chards are placed near the bottom of the wax model. FIG. 16a shows a frontal view of a wax model formed on a stone model of an incisal tooth. FIG. 17a shows the same model from a sagital view. FIG. 16b shows a series of elongated porcelain chards embedded into the wax model. FIG. 17b shows a sagital view of the elongated porcelain chards embedded into the wax model. Preferably, for formation of a gingival restoration, at least one truncated elliptical shaped porcelain disc is embedded into the upper part of the wax model. This is shown in frontal view in FIG. 16c and in sagital view in FIG. 17c.

Any number of different colored shards can be placed on a single wax model in order to form a polychromatic porcelain restoration of the desired color. Preferably, the methodology of placing the shards involves placing opaque shards next to clear and dark grey shards to give the illusion of translucency like that of natural teeth. For formation of a gingival restoration, the characterization is preferably done in a darker tooth colored shade such as a yellow brown or orange shade to mimic the natural staining of the teeth. Shades, intensities and size of shards will vary in accordance with the desired result, which is subjective.

The porcelain shards for use in the present invention can be made by any method. Preferably, the shards are made from pressed flat porcelain disks that are cut to the desired shape with a high speed rotary cutting disk.

The porcelain embedded wax model is then used as above in the formation of a pressable porcelain dental restoration including the sprueing of the model to a ring former base, the formation of the refractory cylinder or other shape around the porcelain embedded wax model, and the wax burnout step. However, in the wax burn out step, only the wax is removed while the embedded porcelain remains in the cavity left by the wax. Porcelain is then pressed into the cavity left by the ring former base as above and the porcelain restoration is divested as above. The resultant porcelain restoration has a natural polychromatic appearance.

When the wax is burned out the shards remain in the solid investment cast until the pressed porcelain is introduced forming a homogenous mass of porcelain. The refractory model is abraded away completely. Depending on the placement of the chards, it may be necessary to remove a portion of the shards from the final restoration. For example, in the formation of an incisal restoration, the portion of the elongated shards that stick out from the wax model may need to be divested from the final restoration after the porcelain is pressed into the cavity.

Another embodiment of the present invention is a porcelain dental restoration formed by using the above process. The only method currently to have a polychromatic prosthesis is to bake the prosthesis onto a refractory model using stackable porcelain (sintered frit) or pressing the prosthesis allowing it to cool, cutting back the porcelain at desired locations and co-mingling with stackable porcelain and reheating until the two materials become homogenous. Stackable porcelain is not as strong (flexural/tensil or compressive strengths) and pressable porcelain combined with stackable are not as strong either. The more times a prosthesis has to be allowed to cool and have another layer applied on the prosthesis it becomes weaker. Thus, the porcelain dental restoration of the present invention is stronger and less susceptible to discoloration with time compared to prior art dental restorations. Moreover, the formation of a stackable porcelain restoration is much more time consuming than the formation of a porcelain dental restoration by the present inventive process because a series of applications and bakes are required for stackable restorations while only a single bake is required in the instant invention.

The porcelain dental restoration of the present invention may include any restoration including but not limited to porcelain laminate veneer, porcelain jacket crown, porcelain labial bridge, porcelain lingual bridge, and porcelain V-crown. The present invention can also be applied to the formation of any dental prosthetic with cosmetic and or restorative applications to be luted to natural dentition. The prosthetic may be formed from porcelain, composite, acrylic, metal (precious, non-precious, semi-precious or alloy) or any other material commonly used.

Although particular embodiments of this invention have been disclosed herein for purposes of explanation, further modifications or variations thereof will be apparent to those skilled in the art to which this invention pertains. Further, although certain processes have been described by a number of steps in a particular order, the present invention is not limited to any particular order. Further, those skilled in the art will recognize that many changes may be made to the lost wax technique without departing from the scope of the present invention. Further, although porcelain is the material mainly discussed, the incorporation of chards of material into a wax model can be applied for any material used to form a dental restoration. Thus, the scope of the present invention is not meant to be limited in any way.

What is claimed is:

1. A method for forming a polychromatic porcelain dental restoration, the method comprising:
forming a wax model of a tooth;
embedding at least a portion of at least one shard of a first porcelain into the wax model;
forming a refractory material around the porcelain shard embedded wax model;
removing the wax of the wax model from within the refractory material to form a void in the shape of the model;
pressing a second porcelain into the void; and
divesting the refractory material from around the pressed porcelain to form a polychromatic porcelain dental restoration.

2. The method of claim 1, wherein the tooth is a incisor and wherein the at least on shard of a first porcelain comprises at least one elongated strip of porcelain.

3. The method of claim 2, wherein the at least one elongated strip of porcelain is about 10 mm long and from about 1 mm to 2 mm wide and deep.

4. The method of claim 1, wherein the tooth is a gingival tooth and wherein the at least on shard of a first porcelain comprises at least one truncated elliptical shaped disc of porcelain.

5. The method of claim 4, wherein the at least one truncated elliptical shaped disc of porcelain is graduated bilaterally to a width of about 4 mm and is about 0.5 mm thick.

6. The method of claim 1, wherein the step of embedding comprises heating the wax model and providing the at least one shard of a first porcelain to the heated wax.

7. The method of claim 1, wherein the first porcelain is a different shade compared to the second porcelain.
